(19) United States
(12) Patent Application Publication
(10) Pub. No.: US 2009/0290006 A1
(43) Pub. Date: Nov. 26, 2009

(54) Droplet discharging apparatus

(76) Inventors: Yoshinori Adachi, Osaka (JP); Kenji Koizumi, Osaka (JP); Akiko Kusumoto, Osaka (JP)

Correspondence Address: MUIRHEAD AND SATURNELLI, LLC, 200 FRIBERG PARKWAY, SUITE 1001, WESTBOROUGH, MA, 01581, US

(21) Appl. No.: 12/311,301

(22) PCT Filed: Oct. 26, 2006
(86) PCT No.: PCT/JP2006/321395

§ 371 Date: Mar. 25, 2009

(51) Int. Cl. B41J 2/19

(52) U.S. Cl. 347/92

(57) ABSTRACT

A droplet discharging apparatus has a flow path connected to a liquid supply path. A nozzle is located downstream of the flow path and discharges liquid drops. A pressure generation element generates pressure for discharging the liquid from the nozzle. The flow path is bent and has a first flow path connected to the liquid supply path and a second flow path connected to the downstream side of the first flow path and causing the liquid to flow in the different direction from the first flow path. That portion of the bend which is from an outer corner of the bend to an outer wall portion of the second flow path is formed in a smooth shape. At the connected sections, the width of the second flow path normal to the direction of flow of the first flow path is set smaller than the width of the first flow path.

### FIELD OF THE INVENTION

The present invention relates to a droplet discharging apparatus and more particularly to a droplet discharging apparatus which has a flow passage communicated with a liquid supply passage, an aperture provided in the downstream side of the flow passage through which droplets are discharged, and a pressure generating device provided in the flow passage for generating a pressure for discharging the droplets through the aperture.

### BACKGROUND OF THE INVENTION

One of such conventional droplet discharging apparatuses is known as disclosed in Patent Citation 1. Patent Citation 1: JP8-58089A

As described in the above citation where a supply of ink is conveyed from a communication passage 38 to a pressure chamber 5, an ink supply orifice 4 is positioned so as not to come opposite to the pressure chamber thus removing unwanted air bubbles with ease. Referring to FIG. 6 of the citation, the pressure chamber 5 is communicated continuously to a nozzle communication passage 39 across a bent, whereby the generation of air bubbles at the upper left corner or one end F of the pressure chamber 5 will be inevitable depending on the type of the ink.

For ease of the description of such a drawback about the generation of air bubbles, an improved modification of the passage is developed as shown in FIG. 21. As the terms of upward, downward, leftward, and rightward are used for ease of the description, they indicate no directions based on the gravitational direction. As shown, a first flow passage 50′ of a disk-like shape is communicated continuously to a second flow passage 60′ of a funnel-like shape which extends in a different direction and further communicates with an aperture 43′, whereby the entire passage extends in a bent form. The pressure for discharging a liquid is generated in the first flow passage 50′ by a pressure generating device oscillating the interval between two, upper and lower, walls 50T, 50B of the first flow passage 50′. It is known that when the liquid is introduced, it produce unwanted air bubbles in the outer corner P1′ at the bent and the acute corners P2′ at the inlet of the second flow passage 60′. Such unwanted air bubbles may also be produced in the outer corner P1′ at the joint between two tubular flow passages 50′, 60′ as shown in FIG. 23. Since the production of air bubbles in the outer corner P1′ and the acute corners P2′ at the inlet absorbs the pressure generated by the pressure generating device, it will interrupt the normal action of discharging the liquid.

In addition, as shown in FIG. 22, the funnel-like shape 61′ of the second flow passage 60′ where the cross section becomes smaller in the diameter causes the liquid front to be converged in steps and thus shifted in the shape as denoted by LS1′ to LS3′. More specifically, the aperture 43′ is filled up before the liquid front denoted by LS3′ comes down to the aperture 43′, whereby a pool of air A will be trapped in the second flow passage 60′ and develops the same drawback as of the air bubbles produced in the outer corner P1′ and the acute corners P2′ at the inlet.

### DISCLOSURE OF THE INVENTION

### Problems that the Invention is to Solve

It is an object of the prevent invention, in view of the above aspects, to provide a droplet discharging apparatus which can avoid the production of unwanted air bubbles in the liquid passage.

### Means for Solving the Problems

It is generally known that the angle of contact between the liquid front and the contact interface between a liquid and a solid is determined by the surface tension of the solid, the surface tension of the liquid, and the interfacial tension between the liquid and the solid. The lower the affinity between the liquid and the solid, the greater the angle of contact will be. The higher the affinity between the liquid and the solid, the smaller the angle of contact will be.

We, the inventors, have found through a series of experiments the following facts. When the angle of contact is great with the affinity between a solid and a liquid remaining low, the liquid enters the second flow passage 60′ before the liquid front reaches the outer corner P1′ after arriving at the inner corners P3′. This results in the generation of air bubbles in the outer corner P1′ due to a pool of air being trapped. Also, as the liquid runs through the acute corners P2′ at the inlet with difficulty, it generates unwanted air bubbles thereabout. More particularly, it was found that the generation of air bubbles much depends on the angle of contact and the form of the flow passage.

For achievement of the foregoing object in view of the above described aspects, a droplet discharging apparatus is provided as a first feature of the present invention, which has a flow passage communicated with a liquid supply passage, an aperture provided for discharging droplets of a liquid from the flow passage, and a pressure generating device for generating a pressure in the flow passage in order to discharge the liquid, in which

the flow passage comprises a first flow passage communicated with the liquid supply passage and a second flow passage communicated to the downstream end of the first flow passage for allowing the liquid to flow in a direction which is different from the direction of flow in the first flow passage as is arranged to turn at a bent and its surface extending from the outer corner at the bent to the wall at the outer side of the second flow passage is gently curved, and

the width of the second flow passage which extends at a right angle to the direction of flow in the first flow passage is narrower than the width of the first flow passage at the joint between the two passage or at a location close to the joint.

According to the above arrangement, the surfaces, denoted by 50 W and 60 W, which extend from the outer corner P1 at the bent to the wall at the outer side of the second flow passage 60 are gently curved as shown in FIGS. 3 to 6, thus avoiding the generation of air bubbles. Since side margin areas 53 are provided on either or both, left and right, sides of the inlet of the second flow passage 60, they allow the liquid running through the first flow passage 50 to reach the outer corner P1 with much ease. This prevents the liquid on the inner corner P3 from entering first the second flow passage 60 and causing the generation of air bubbles.

As a second feature of the present invention, the apparatus may be characterized, in place of and/or in addition to the arrangement at the width of the second flow passage in the first feature, in that the relationship at the joint between the two passages or at a location close to the joint between the depth D in the second flow passage which extends along the direction of flow in the first flow passage and the maximum width W of the first flow passage which extends at a right angle to the direction of flow in the first flow passage within a location between the outer corner and the inner corner at the bent is expressed by D/W<0.4.

As apparent from the analysis over the prescribed problems, the generation of air bubbles in the outer corner P1 is triggered by the liquid reaching the outer corner P1 with a delay after running through the first flow passage 50. Because the generation of air bubbles is avoided when the depth D of the second flow passage which represents the distance to the outer corner P1 is short, we, the inventors, have found through a series of experiments that the conditions for avoiding the generation of unwanted air bubbles are satisfied by the relationship between the depth D and the width W.

As a third feature of the present invention, the apparatus may be characterized, in place of and/or in addition to the arrangement at the width of the second flow passage in the first feature, in that the inner corner at the bent and/or at least a part of the inner side at the bent of the first flow passage (referred to as an inner side hereinafter) is greater in the resistance to the flow of the liquid than the other surfaces.

According to the third feature, the liquid running over the inner corner P3 can be prevented from entering first the second flow passage 60 before the liquid front running through the first flow passage 50 reaches the outer corner P1, hence avoiding the generation of air bubbles in the outer corner P1. For increasing the resistance against the flow of the liquid on an inner side, the surface of interest may be subjected to any applicable process for increasing the resistance or the other surfaces may be subjected to a process for decreasing the resistance.

As a fourth feature of the present invention, the apparatus may be characterized, in place of and/or in addition to the arrangement at the width of the second flow passage in the first feature, in that the cross section at the joint between the two passages which extends at a right angle to the direction of flow in the second flow passage is outlined by lines and/or curves which are joined at obtuse angles.

According to the arrangement, the acute corners are not present at the inlet of the second flow passage, whereby the liquid can easily run through the corners thus avoiding the generation of unwanted fir bubbles.

Furthermore, we, the inventors, have found through a series of experiments that the problem shown in FIG. 22 takes place when the angle of contact is small with the affinity between solid and liquid being high.

For eliminating the above problem, the apparatus may be characterized as a fifth feature of the present invention, in place of and/or in addition to the arrangement at the width of the second flow passage in the first feature, in that the wall surface of the second flow passage is positioned at the outer side of the plane which linearly extends between the inlet and the outlet of the second flow passage.

According to the arrangement, as shown in FIG. 7, the liquid running from the first flow passage 50 to the second flow passage 60 expands along the tubular inner surface 61 as is denoted by LS1 and then slowly moves down with its upper and lower ends denoted by LS 2 to LS5 respectively along the reduced inner surface 62. This prevents the liquid from shutting up the aperture 43 before the upper end of its front runs down, thus avoiding the generation of air bubbles.

### ADVANTAGES OF THE INVENTION

As set forth above, the first to third features of the present invention allow the generation of unwanted air bubbles to be avoided in the outer corner P1′ of the flow passage. According to the fourth feature, the generation of air bubbles can be avoided particularly at the acute corners P2′ at the inlet. According to the fifth feature, the generation of air bubbles can be avoided particularly in the second flow passage. Using any combination of the features, their advantages can create a synergy effect.

The apparatus according to the present invention has a bent in the flow passage so that the freedom of design about a location close to the aperture can be improved. Also, since the generation of unwanted air bubbles are avoided with the structural improvement, the angle of contact which is determined by the viscosity and type of the liquid to be used and the materials of the structure of the flow passage can be less limited while the freedom of selecting the type of the liquid is increased, hence significantly improving the efficiency of the experiment as well as the production.

Other objects, arrangements, and advantages of the present invention will be apparent from the following description of embodiments of the present invention.

### BRIEF DESCRIPTION OF THE DRAWINGS

FIG. 1 is a longitudinally cross sectional view of a head;

FIG. 2 is a plan view showing an arrangement in the proximity of a projection and a communication aperture;

FIG. 3 is a longitudinally cross sectional view of a lower region of the head;

FIG. 4 is a perspective view showing flow passages;

FIG. 5 is a perspective view, similar to FIG. 4, seen from the lower;

FIG. 6 is a plan view showing an arrangement in the proximity of the joint between a first flow passage and a second flow passage;

FIG. 7 is a longitudinally cross sectional view showing an arrangement in the proximity of the second flow passage;

FIG. 8 illustrates flow passages in the second embodiment, FIG. 8A being a perspective view, FIG. 8B being a side view, and FIG. 8C being a cross sectional view taken along the line A-A;

FIG. 9 illustrates flow passages in the third embodiment, FIG. 9A being a perspective view, FIG. 9B being a side view, and FIG. 9C being a cross sectional view taken along the line A-A;

FIG. 10 illustrates flow passages in the fourth embodiment, FIG. 10A being a perspective view, FIG. 10B being a side view, and FIG. 10C being a cross sectional view taken along the line A-A;

FIG. 11 illustrates flow passages in the fifth embodiment, FIG. 11A being a perspective view, FIG. 11B being a side view, and FIG. 11C being a cross sectional view taken along the line A-A;

FIG. 12 is a longitudinally cross sectional view of flow passages showing the sixth embodiment;

FIG. 13 is a longitudinally cross sectional view of flow passages showing the seventh embodiment;

FIG. 14 is a longitudinally cross sectional view of flow passages showing the eighth embodiment;

FIG. 15 is a longitudinally cross sectional view of flow passages showing the ninth embodiment;

FIG. 16 is a longitudinally cross sectional view of flow passages showing the tenth embodiment;

FIG. 17 is a perspective view similar to FIG. 16;

FIG. 18 is a longitudinally cross sectional view of flow passages showing the eleventh embodiment;

FIG. 19 is a perspective view similar to FIG. 18;

FIG. 20 is a longitudinally cross sectional view showing an arrangement in the proximity of a second flow passage in a modification of the embodiment shown in FIG. 7;

FIG. 21 illustrates a drawback of the flow passages, FIG. 21A being a perspective view and FIG. 21B being a bottom view;

FIG. 22 is a comparison view similar to FIG. 7; and

FIG. 23 is an explanatory view of troublesome regions in the flow passages, FIG. 23A illustrating the flow passage of a square shape in the cross section and FIG. 23B illustrating the flow passage of a circular shape in the cross section.

### DESCRIPTION OF NUMERALS

1: droplet discharging apparatus, 2: head, 10: piezoelectric device, 10a: holding portion, 10b: activating portion, 10c: contact portion, 10d: lower end, 20: bracket, 21: channel, 22: upper open region, 23: mounting region, 24: cavity region, 27: communication inlet, 27c: supply passage, 30: oscillator plate, 30a: lower side, 31: projection, 32: diaphragm (oscillating membrane), 33: recessed portion, 34: upper side, 35: supply passage, 36: communication aperture, 40: nozzle plate, 41: nozzle (third flow passage), 42: recess, 43: aperture, 50: first flow passage, 50w: lower side wall, 50T: upper wall, 50B: lower wall, 52: side corner, 53: margin area, 55a to 55f: flow resistive surfaces, 60: second flow passage, 60a: inlet, 60b: outlet, 60w: wall at outer side, 61: tubular inner surface, 62: reduced surface, 63: flat surface, D: depth of second flow passage, W: width of first flow passage, JP: joint, PG: flow passages, P1: outer corner, P2: acute corner at inlet, P3: inner corner.

### BEST MODES FOR EMBODYING THE INVENTION

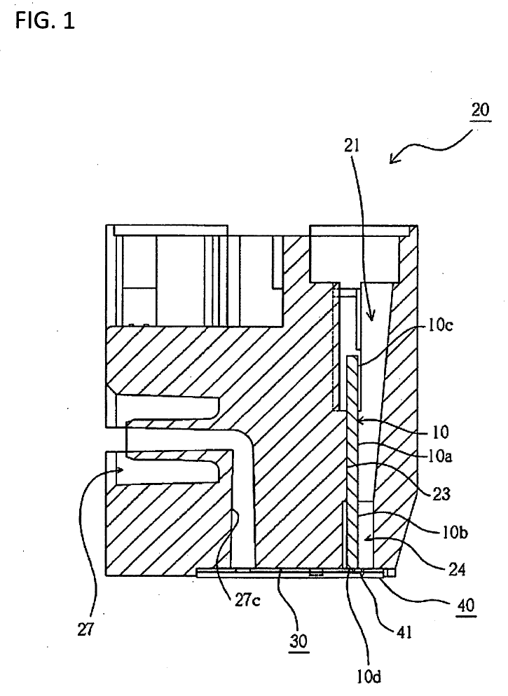

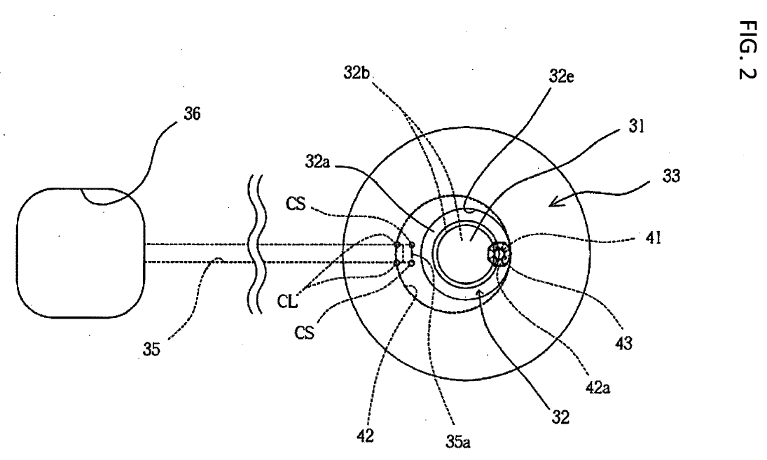

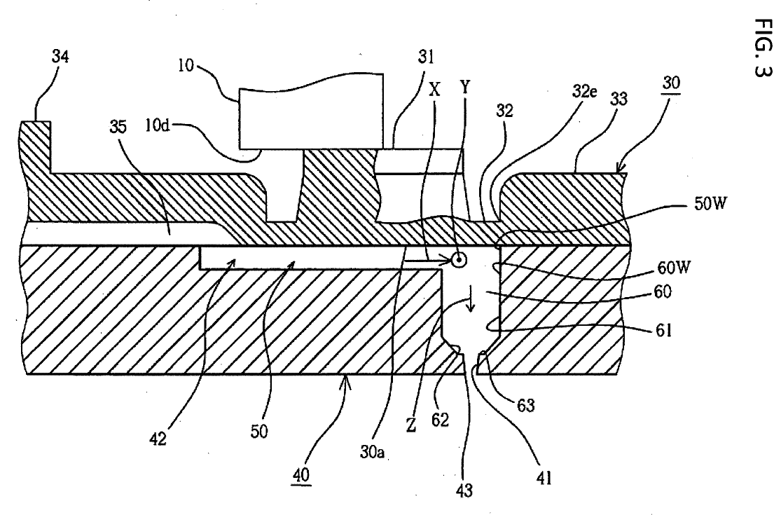

The first embodiment of the present invention will be described referring to FIGS. 1 to 7. It would be noted that the terms of upward, downward, leftward, and rightward used in this specification are only applied for ease of the description but not limited to the absolute gravitational direction.

As shown in FIGS. 1 to 3, a droplet discharging apparatus 1 according to the present invention includes a head 2 for discharging a liquid supplied from a cartridge, not shown, in the form of droplets from an aperture 43 provided in the lower end of a nozzle 41. The head 2 comprises a piezoelectric device 10 acting as a pressure generating device, an oscillator plate 30, and a nozzle plate 40 fixedly mounted to a bracket 20 and a group of contactor, upper cover, and cables which are not shown but secured to the bracket 20. The not shown upper cover, the bracket 20, the oscillator plate 30, and the nozzle plate 40 are shaped by injection molding of a resin material. Alternatively, the material may be a glass or metallic material while the shaping may be implemented by etching or electro-forming technique.

The bracket 20 has a channel 21 provided therein to extend from the upper end to the lower end for guiding the piezoelectric device 10, in which an upper open region 22, amounting region 23, and a cavity region 24 are defined from the upper to the lower of the guiding channel 21. The bracket 20 also has a communication inlet 27 provided in the back side thereof for communicating with a cartridge. The oscillator plate 30 and the nozzle plate 40 are fitted to the lower side of the bracket 20. A combination of the oscillator plate 30 and the nozzle plate 40 fitted to the lower side of the bracket 20 form a pressure chamber actuated by the piezoelectric device 10 and a flow passage acting as a nozzle at the lower side of the head 2.

The piezoelectric device 10 may be constructed by, for example, a PZT (lead zirconate titanate) material where its actuating portion 10b at the lower end can be expanded and contracted by energization. With its center holding portion 10a fixedly mounted to the bracket 20, the piezoelectric device 10 causes its lower end 10d to be oscillated up and down thus producing the oscillating action of a diaphragm 32 through a projection 31 which will be described later. The piezoelectric device 10 is arranged of a square shape in the cross section while its distal end is located in the cavity region 24 of the bracket 20 when having been inserted from the upper open region 22 and secured at the mounting region 23. The piezoelectric device 10 is fixedly mounted at the mounting region 23 to the bracket 20 by an adhesive.

The oscillator plate 30 has the projection 31, the diaphragm 32, and a recessed portion 33 thereof situated closely beneath the lower end of the guiding channel 21. The oscillator plate 30 also has a groove 35 provided in the lower side thereof for communicating with a recess 42 provided in the nozzle plate 40.

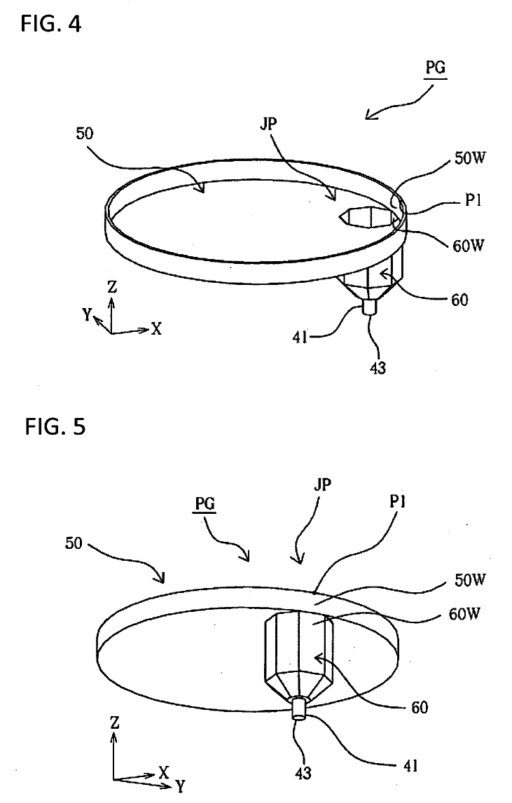

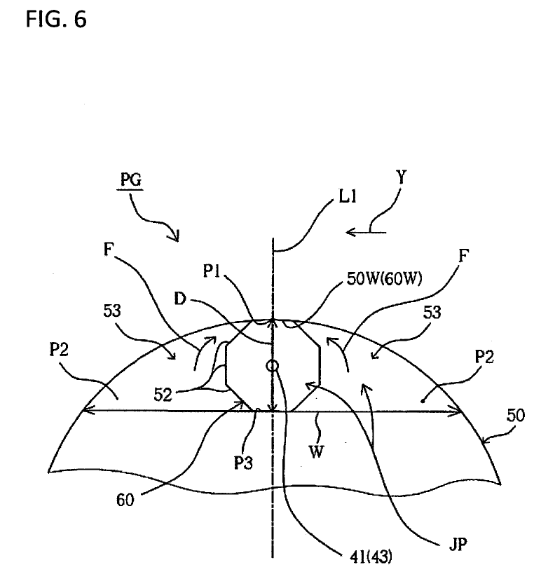

The projection 31, the diaphragm 32, and the recessed portion 33 are arranged coaxially in a circular form at the boundary as shown in FIGS. 4 and 6 while they become larger in the diameter in this order. The piezoelectric device 10 is bonded at its lower side 10d by an adhesive to a part of the projection 31. The recessed portion 33 of the oscillator plate 30 is arranged greater at the outer edge than the lower end 10d so that the upper side 34 remains not in direct contact with the lower side 10d.

As the recess 42 in the nozzle plate 40 is covered with the lower side 30a of the oscillator plate 30, it forms a first flow passage 50 which acts as a pressure chamber for communicating via a second flow passage 60 to the nozzle 41. The first flow passage 50 is supplied with a liquid which is introduced from the communication inlet 27, into which the cartridge is inserted, and conveyed through a supply passages 27c, 35, and a communication aperture 36.

FIGS. 4 to 6 illustrate a pattern of the flow passages denoted by PG where the first and second flow passages 50, 60 only are outlined. As the first flow passage 50 is arranged of a disk-like shape, it communicates at the downstream end to the second flow passage 60 which extends downwardly at a right angle to the disk-like shape of the first flow passage 50, whereby the two passages form a bent passage. The terms of inner side and outer side in this application are used for defining the inner side and the outer side respectively of the bent. The second flow passage 60 is arranged of an octagonal shape in the cross section as defined by a tubular inner surface 61 and a reduced inner surface 62 which extends continuously from the tubular inner surface 61 as becoming smaller in the diameter towards a flat surface 63. The nozzle 41 and the aperture 43 are provided in the flat surface 63. The nozzle 41 in this embodiment acts as a third flow passage while the aperture 43 is at the downstream end of the third flow passage.

Since the second flow passage 60 has an octagonal shape at the inlet in the cross section with its side walls remaining joined one another at an obtuse angle, it can avoid the generation of unwanted air bubbles which may result from the liquid entering with no smoothness. One particular side of the octagonal shape makes an arcuate outer wall 60w which extends smoothly with no step from the downstream side wall 50w of the first flow passage 50, thus allowing the liquid front upon reaching the outer corner P1 of the first flow passage 50 to be smoothly guided to the lower. As an inner corner P3 is defined at the upstream side of the inlet, side corners 52 extend between the inner corner P3 and the downstream side wall 50w.

Since the second flow passage 60 in this embodiment is narrower in the width along a direction Y, which extends at a right angle to the direction X of flow in the first flow passage 50, than the first flow passage 50 and thus produces two margin areas 53 at both, left and right, sides of the joint JP, it allows the liquid front to smoothly run along the margin areas towards the outer corner P1 as denoted by the arrows F. Simultaneously, the cross section at the joint JP to the second flow passage 60 is defined by obtuse angles. Moreover in this embodiment, the width W at the inner corner P3 of the first flow passage 50 along the direction Y and the depth D at the joint JP of the second flow passage 60 along the direction X are determined so that D/W<0.4 is established.

When the liquid is great in the angle of contact, it can not directly run over the inner corner P3 and the side corners 52 before entering the second flow passage 60 but flow along the side margin areas 53 towards the outer corner P1 as dented by the arrows F, hence avoiding the generation of unwanted air bubbles. In addition, since the cross section at the joint JP to the second flow passage 60 is defined by the obtuse angles, it can also avoid the generation of unwanted air bubbles. On the other hand, when the liquid is small in the angle of contact, its front can reach the outer corner P1 after running along the side margin areas 53 before entering the second flow passage 60 over the inner corner P3, hence avoiding the generation of unwanted air bubbles.

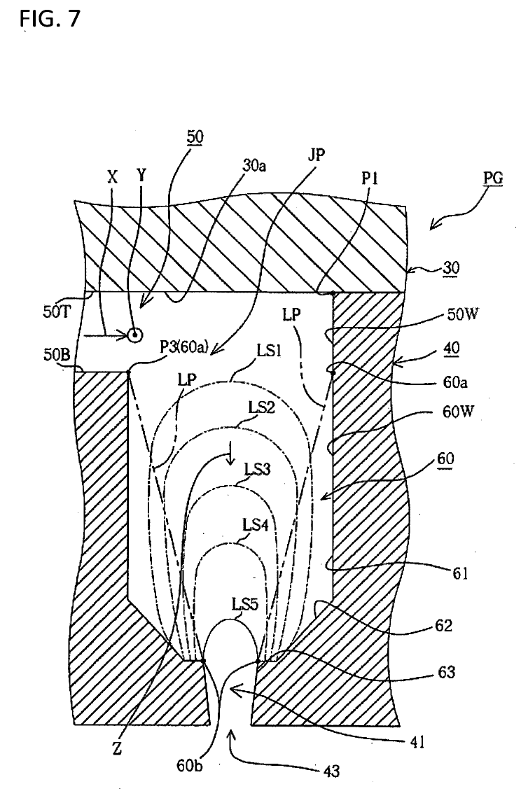

Furthermore, as shown in FIG. 7, the tubular inner surface 61 and the reduced inner surface 62 of the second flow passage 60 can avoid the generation of unwanted air bubbles in their combination. More specifically, the inner surfaces 61, 62 remain located at the outside of the imaginary plane LP defined by lines which extend between the inlet 60a and the outlet 60b of the second flow passage 60 so that the liquid front runs as is denoted by LS1 to LS5. This allows the intervals of time between phases of the liquid front to be slowed down, hence avoiding the generation of unwanted air bubbles in the second flow passage 60. With a total of the above described effects, the pressure on the liquid by the oscillating action of the upper wall 50T can be dissipated with higher certainty for discharging the droplets at favorable conditions.

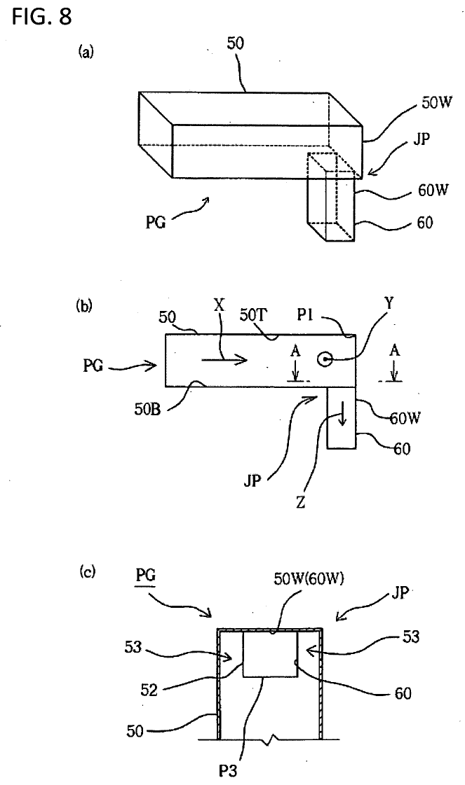

The droplet discharging apparatus 1 of this embodiment may be modified in various manners without departing from the scope and spirit of the present invention. For example, such modifications as shown in FIGS. 8 to 11 may be made for embodying the first feature of the present invention with the use of different flow passages. In the modification shown in FIG. 8, both the first flow passage 50 and the second flow passage 60 in the flow passages pattern PG are arranged of a square shape in the cross section while the second flow passage 60 is smaller in the width than the first flow passage 50 with the side margin areas 53 situated on both, left and right, sides of the joint JP to the second flow passage 60. Alternatively, the second flow passage 60 may be biased towards one side of the first flow passage 50 so that the side margin area 53 is provided only at one side.

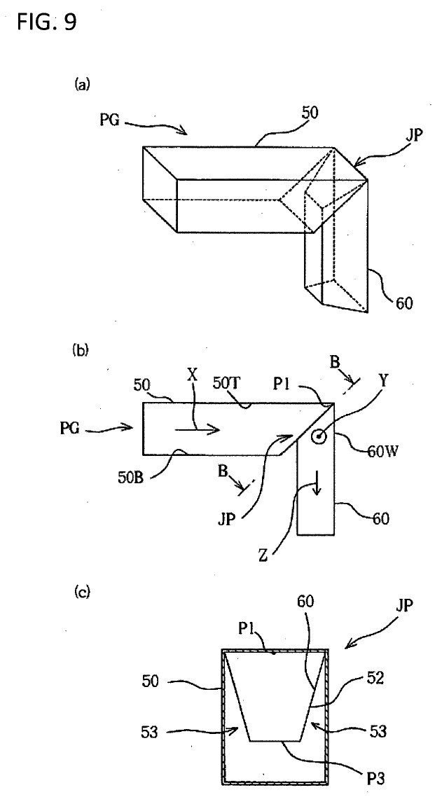

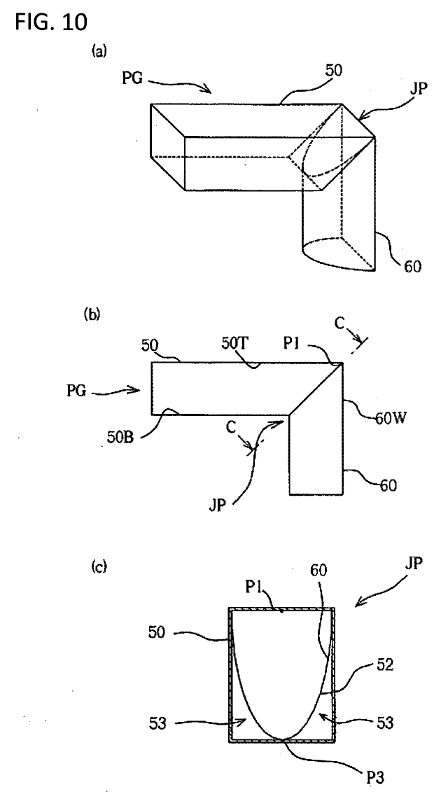

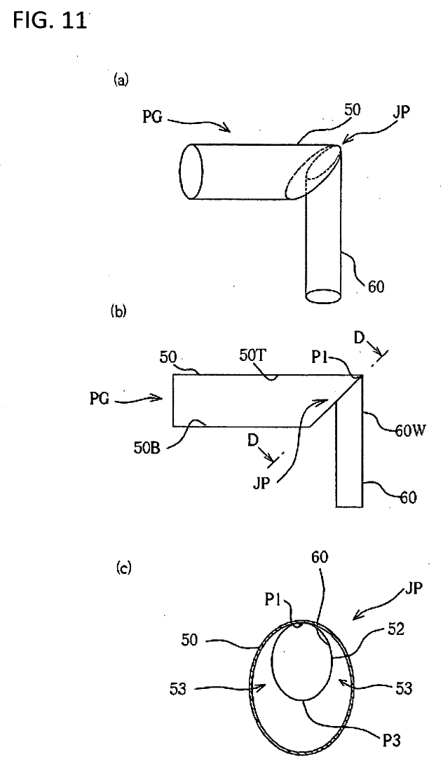

In the modification shown in FIG. 9, the join JP between the first flow passage 50 and the second flow passage 60 is arranged at an angle while the second flow passage 60 is arranged of a trapezoid shape in the cross section. In the modification shown in FIG. 10, the second flow passage 60 is arranged of a semi-elliptical shape in the cross section. In the modification shown in FIG. 11, both the first flow passage 50 and the second flow passage 60 are arranged of a circular shape in the cross section.

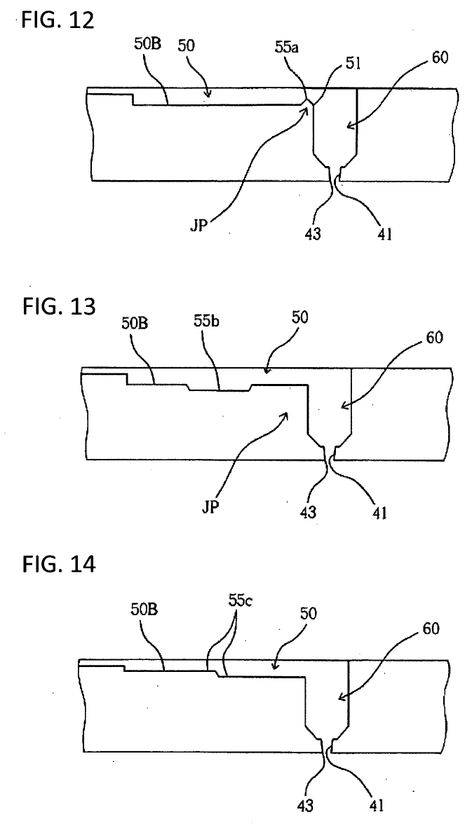

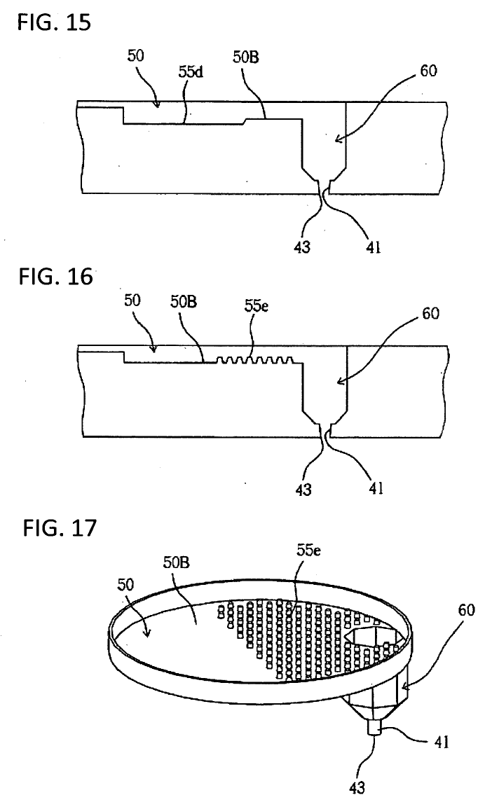

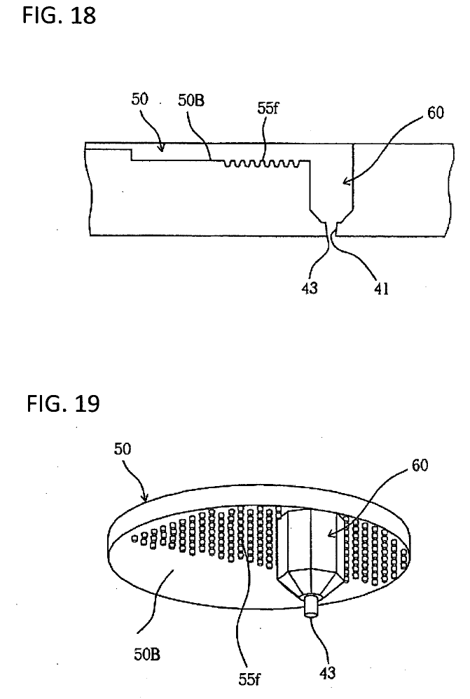

Other modifications may be made for embodying the third features of the present invention, as shown in FIGS. 12 to 19. In the modification shown in FIG. 12, a flow interruption 55a is provided in the form of a projection at the inner corner P3. Alternatively, the flow interruption 55a may be provided at each side corner 52. In the modifications shown in FIGS. 13 to 15, flow interruptions 55b, 55c, 55d are provided in the form of steps on the lower wall 50B. In the modifications shown in FIGS. 16 and 17, flow interruptions 55e are provided in the form of projections on the lower wall 50B. In the modifications shown in FIGS. 18 and 19, flow interruptions 55f are provided in the form of recesses in the lower wall 50B. Alternatively, the flow interruptions 55a to 55f may be provided, for example, with the use of a surface treating technique for increasing the resistance against the flow at the areas of interest. Also, the other area than the flow interruptions 55a to 55f may be subjected to another surface treating technique for decreasing the resistance against the flow so that the center area becomes relatively higher in the resistance than the other areas. The surface treating technique may be placed by the use of a different material at the areas of interest.

The cross section of the tubular inner surface 61 is not limited to the octagonal shape but may be arranged of any appropriate shape such as an unequally-sided polygonal shape, an uneven circular shape, or a combination of different curves. While the aperture 43 and the tubular inner surface 61 are not limited to the concentric relationship, their concentric relationship may be preferable for ensuring the stability in the operation.

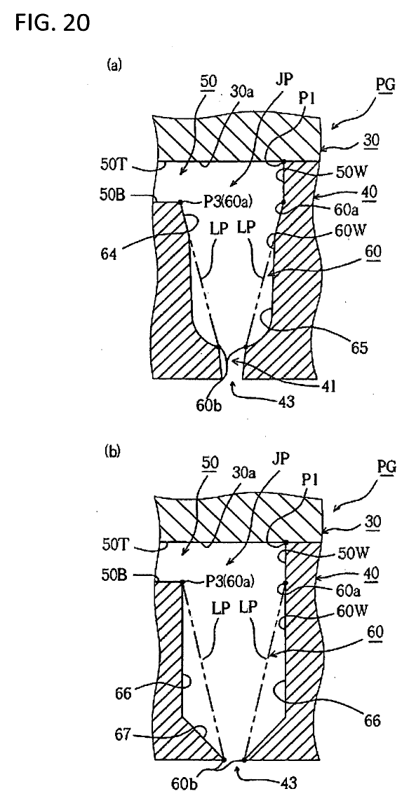

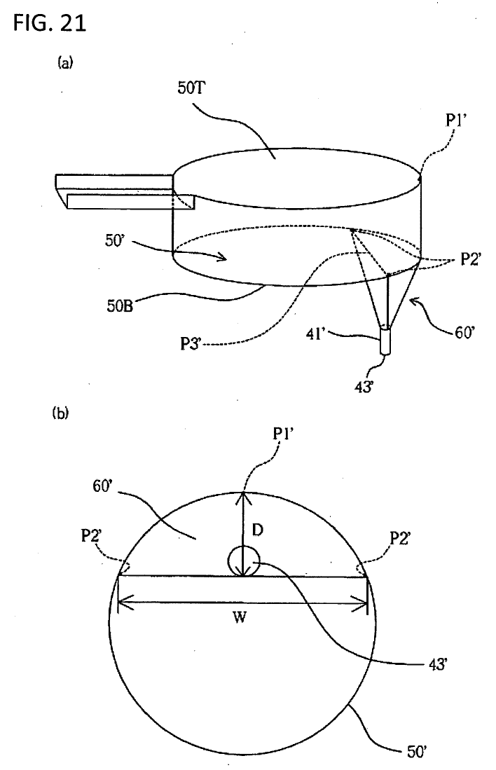

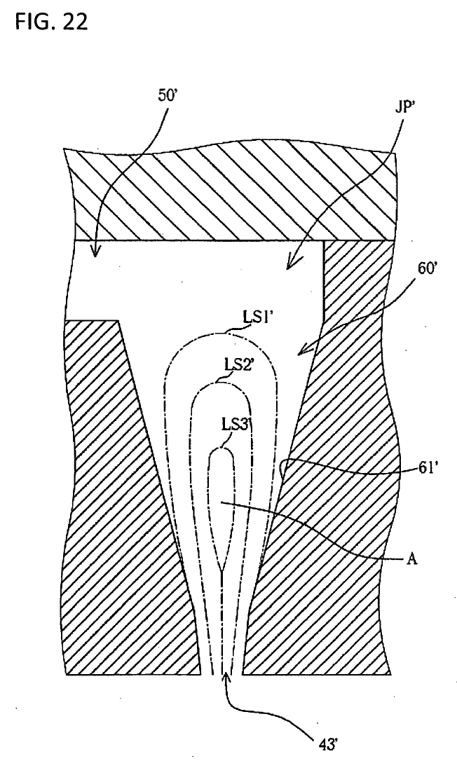

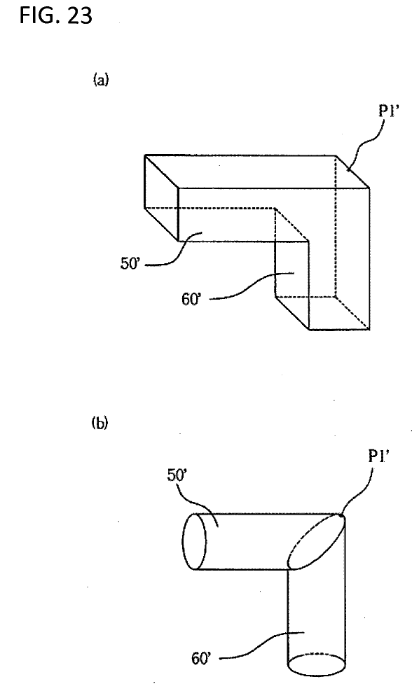

The second flow passage 60 may be arranged of such a shape as shown in FIG. 20. For example, the passage 60 may be defined by a reduced inner surface 64 and a curved surface 65 which are fitted to the imaginary plane LP as shown in FIG. 20A. Alternatively, the passage 60 may be defined by a tubular round surface 66 and a reduced surface 67 as shown in FIG. 20B. In the latter case shown in FIG. 20B, the aperture 43 coincides with the outlet 60b of the second flow passage 60.

In the foregoing embodiments, the pressure generating device is implemented by a piezoelectric device. Alternatively, the pressure generating device may be implemented by a resistance heating element which can boil the liquid in order to generate the pressure. In any case, the action of the pressure generating device fundamentally involves oscillating a part of the first flow passage 50 and applying a pressure to either the first flow passage 50 or the second flow passage 60.

While the outer corner P1 in each of the embodiments is provided of an order where unwanted bubble may be produced (or may stagnate), it may be rounded.

### INDUSTRIAL APPLICABILITY

The present invention is applicable to chemical experiments, biotechnology experiments, medical diagnosis, electronics production, and so on. The liquid may be selected from various types. For example, the liquid may contain biological materials such as DNA, protein, or fungus, fluorescent particles, electrically conductive particles, resin particles, ceramic particles, pigments, or dyes. It is suitable for discharging droplets of high surface-tension liquid such as water or expensive liquid. It is also suitable for drawing lines through printing as well as fabricating electrodes and micro-lenses. Moreover, the present invention is favorable for applying an array of droplets at desired locations such as forming biological chips, producing flavors through dispensing or spraying, providing a mixture through controlling the amount to be discharged, or forming films.

1. A droplet discharging apparatus comprising:
a flow passage communicated with a liquid supply passage;
an aperture for discharging droplets of a liquid from the flow passage; and a pressure generating device for generating a pressure in the flow passage in order to discharge the liquid,
wherein the apparatus is adapted for use with two or more different types of the liquid which are different in the angle of contact to the flow passage,
wherein the flow passage comprises a first flow passage communicated with the liquid supply passage and a second flow passage communicated to the downstream end of the first flow passage for allowing the liquid to flow in a direction which is different from the direction of flow in the first flow passage as is arranged to turn at a bent and its surface extending from the outer corner at the bent to the wall at the outer side of the second flow passage is configured integral with the wall at the outer side with no step; and
wherein the width of the second flow passage which extends at a right angle to the direction of flow in the first flow passage is narrower than the width of the first flow passage at the joint between the two passage or at a location close to the joint so that margin areas extending along the widthwisely narrowed direction are provided between the first flow passage and the second flow passage thus to avoid the generation of air bubbles at the introduction of the liquid.

2. A droplet discharging apparatus, comprising:
a flow passage communicated with a liquid supply passage;
an aperture for discharging droplets of a liquid from the flow passage; and
a pressure generating device for generating a pressure in the flow passage in order to discharge the liquid,
wherein the apparatus is adapted for use with two or more different types of the liquid which are different in the angle of contact to the flow passage, wherein the flow passage comprises a first flow passage communicated with the liquid supply passage and a second flow passage communicated to the downstream end of the first flow passage for allowing the liquid to flow in a direction which is different from the direction of flow in the first flow passage as is arranged to turn at a bent and its surface extending from the outer corner at the bent to the wall at the outer side of the second flow passage is configured integral with the wall at the outer side with no step, and
wherein the relationship at the joint between the two passages or at a location close to the joint between the depth D in the second flow passage which extends along the direction of flow in the first flow passage and the maximum width W of the first flow passage which extends at a right angle to the direction of flow in the first flow passage within a location between the outer corner and a inner corner at the bent is expressed by
D/W<0.4,
whereby the generation of air bubbles will be avoided.

3. The droplet discharging apparatus according to claim 1,
wherein at least one of: the inner corner at the bent and at least a part of the inner side at the bent of the first flow passage is greater in the resistance to the flow of the liquid than the other surfaces.

4. The droplet discharging apparatus according to claim 1,
wherein the cross section at the joint between the two passages which extends at a right angle to the direction of flow in the second flow passage is outlined by at least one of: lines and curves which are joined at obtuse angles.

5. The droplet discharging apparatus according to claim 1,
wherein the wall surface of the second flow passage is positioned at the outer side of the plane which linearly extends between the inlet and the outlet of the second flow passage.

6. The droplet discharging apparatus according to claim 2, wherein at least one of: the inner corner at the bent and at least a part of the inner side at the bent of the first flow passage is greater in the resistance to the flow of the liquid than the other surfaces.

7. The droplet discharging apparatus according to claim 2, wherein the cross section at the joint between the two passages which extends at a right angle to the direction of flow in the second flow passage is outlined by at least one of: lines and curves which are joined at obtuse angles.

8. The droplet discharging apparatus according to claim 2, wherein the wall surface of the second flow passage is positioned at the outer side of the plane which linearly extends between the inlet and the outlet of the second flow passage.
